(19) United States
(12) Patent Application Publication
(10) Pub. No.: US 2003/0151693 A1
(43) Pub. Date: Aug. 14, 2003

(54) Video signal processor processing color signals whose bands are limited

(75) Inventors: Hirofumi Honda, Yamanashi-ken (JP); Kenji Okumichi, Yamanashi-ken (JP)

Correspondence Address: SUGHRUE MION, PLLC, 2100 PENNSYLVANIA AVENUE, N.W., WASHINGTON, DC, 20037, US

(73) Assignee: PIONEER CORPORATION

(21) Appl. No.: 10/350,135

(22) Filed: Jan. 24, 2003

(30) Foreign Application Priority Data
Feb. 12, 2002 (JP) P2002-33930

(51) Int. Cl. H04N 5/213

(52) U.S. Cl. 348/631; 348/630

(57) ABSTRACT

A video signal processor is provided to receive a luminance signal, a color-difference signal, and a color signal. The processor comprises a circuit for calculating a low-frequency component of the luminance signal, a circuit for calculating a low-frequency component of the color-difference signal, and a circuit for extracting a high-frequency component of the color signal. The processor also comprises a division circuit, a multiplication circuit, and an addition circuit. In the division circuit, the low-frequency component of the color-difference signal is divided by the low-frequency component of the luminance signal, and in the multiplication circuit, an output signal from the division circuit is multiplied by the high-frequency component of the signal extracted, a multiplied signal being outputted as a correction signal for the color signal. In the addition circuit, the correction signal is added to the color signal.

### BACKGROUND OF THE INVENTION

The present invention relates to a video signal processor applicable to various systems such as television receivers, and in particular, to the video signal processor capable of widening the bands (frequency bands) of color-difference signals in color signals for improved color resolution.

Currently, in television broadcasting, a TV camera is used to image objects, so that primary color signals (R, G and B) are obtained by the TV camera. The primary color signals (R, G and B) are then converted into a luminance signal (Y signal) and color-difference signals (such as T-Y, B-Y, and others). The color-difference signals are subjected to limitation processing of their frequency bands (hereinafter, simply referred to as bands), before being modulated with a color sub-carrier wave so as to be multiplexed to the luminance signal to be transmitted. This way of signal processing is based on the fact that the human's visual performance is lower in sensitivity than high-frequency components of the color-difference signals.

Accordingly, when a television receiver demodulates a video signal that has been received and processed it for display, it is true that the bands of the color-difference signals are narrower than that of the luminance signal. Those narrow bands of the color-difference signals will deteriorate color resolution, thereby causing color blurs at boundaries at which color tones change.

### SUMMARY OF THE INVENTION

The present invention has been made in view of the above circumstances, and an object of the present invention is, therefore, to provide a video signal processor capable of receiving a video signal and improving color resolution by widening the band of each of the color-difference signals in the color signals received as the video signal.

In order to accomplish the above object, there is provided a video signal processor to which a luminance signal, a color-difference signal, and a color signal are supplied, comprising: a first low-frequency component calculating circuit for calculating a low-frequency component of the luminance signal; a second low-frequency component calculating circuit for calculating a low-frequency component of the color-difference signal; a high-frequency component extracting circuit for extracting a high-frequency component of the color signal or the luminance signal; a division circuit for dividing the low-frequency component of the color-difference signal by the low-frequency component of the luminance signal; a multiplication circuit for multiplying an output signal from the division circuit by the high-frequency component of the signal extracted from the high-frequency component extracting circuit, a multiplied signal being outputted as a correction signal for the color signal; and an addition circuit for adding the correction signal to the color signal.

Hence, a ratio between a high-frequency component of each color-different signal whose band is not limited and a high-frequency component of a luminance signal can be estimated by using a ratio between a low-frequency component of the band-limited color-difference signal and the luminance signal. The latter ratio can be used as a multiplication coefficient to correct a high-frequency component of each band-limited color signal. The multiplication coefficient serves, therefore, as a correction value for the high-frequency component of each color signal. Accordingly, the band of each color-difference signal, which is contributory to color resolution, can be widened in the color signals, so that the color resolution can be improved.

It is preferred that the video signal processor further comprises a gain adjusting circuit for adjusting a gain for the correction signal outputted from the multiplication circuit. The gain of the correction signal, which is outputted from the multiplication circuit to the addition circuit, can be adjusted with ease.

### BRIEF DESCRIPTION OF THE DRAWINGS

Other objects and aspects of the present invention will become apparent from the following description and embodiment with reference to the accompanying drawings in which:

FIG. 1 is a block diagram showing one embodiment of a video signal processor according to the present invention;

FIG. 2 is a waveform chart showing a gain of each filter employed by the video signal processor in the embodiment;

FIG. 3 shows the input-output characteristic of a clipping circuit employed by the video signal processor; and

FIG. 4 illustrates the principle of processing carried out by the video signal processor in the embodiment.

### DETAILED DESCRIPTION OF THE PREFERRED EMBODIMENT

The present invention will now be described based on a preferred embodiment.

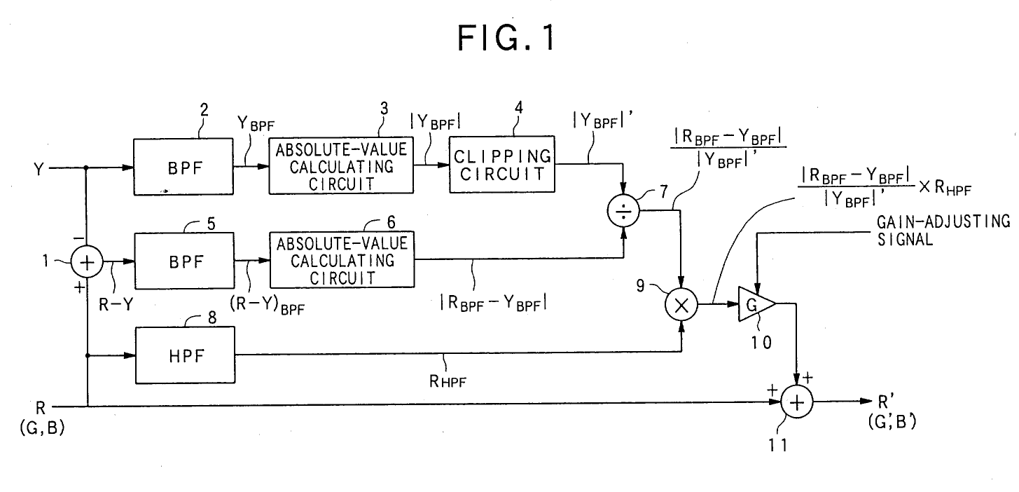

A video signal processor according to the present embodiment is shown in FIG. 1, in which band-limited color signals are represented by R (red), G (green) and B (blue) signals and color signals whose bands are already not limited are represented by R′ (red), G′ (green) and B′ (blue) signals. FIG. 1 shows the configuration to process only the band-limited color signal R into its color signal R of which band is already not limited.

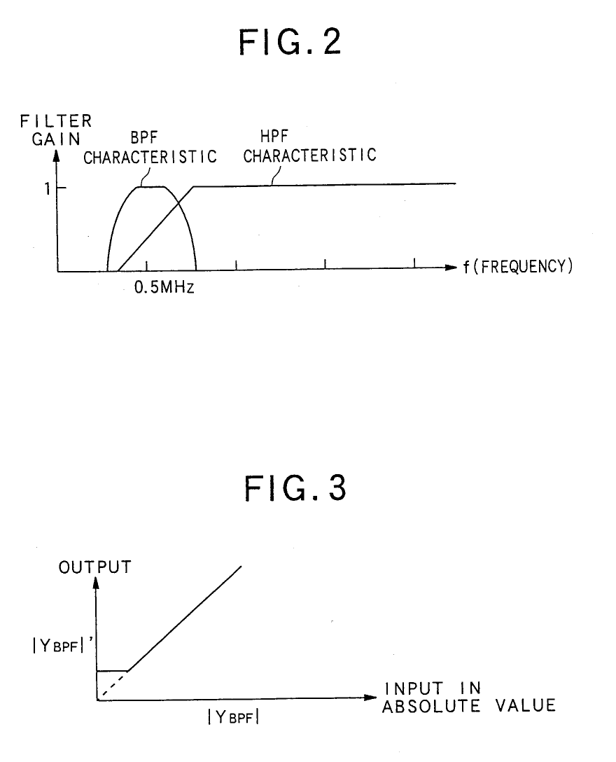

As shown in FIG. 1, the video signal processor has a subtraction circuit 1, to which both of a color signal R and a luminance signal Y are supplied from a TV camera. The subtraction circuit 1 operates to produce a color-difference signal R-Y. The luminance signal Y is also supplied directly to a band-pass-filter (BPF) 2 serving as a first low-frequency component calculation circuit of the present invention, in which a low-frequency component of the luminance signal Y is calculated, as shown in FIG. 2, to produce a signal of Y_{BPF}.

In the present embodiment, the low-frequency component from the BPF 2 means a low-frequency component in which a DC component is not included. This is also true of a later-described BPF 5.

This signal Y_{BPF} is then sent to an absolute-value calculating circuit 3, so that an absolute signal of |Y_{BPF}| is outputted from the absolute-value calculating circuit 3.

The absolute signal |Y_{BPF}| is sent to a clipping circuit 4, in which the signal |Y_{BPF}| is subjected to clipping to prevent the absolute signal |Y_{BPF}| from being lowered than a threshold, as illustrated in FIG. 3, with the result that the absolute signal |Y_{BPF}| is clipped to generate a signal of |Y_{BPF}|′.

The color-difference signal R-Y that has been produced by the subtraction circuit 1 is outputted to another BPF 5 serving as a second low-frequency component calculating circuit of the present invention. Like the foregoing BPF 2, the BPF 5 has a BPF characteristic shown in FIG. 2, so that this characteristic allows the inputted color-difference signal R-Y to undergo calculation of its low-frequency component, thus a signal of (R-Y)_{BPF} being produced. The produced signal (R-Y)_{BPF} is then supplied to another absolute-value calculating circuit 6, whereby a signal of |R_{BPF}−Y_{BPF}| is generated.

Thus, both of a signal of |Y_{BPF}|′, which is a low-frequency component of the luminance signal outputted from the clipping circuit 4, and a signal of |R_{BPF}−Y_{BPF}|, which is a low-frequency component of the color-difference signal outputted from the absolute-value circuit 6, are supplied to a division circuit 7. The division circuit 7 is able to divide the |R_{BPF}−Y_{BPF} signal by the |Y_{BPF}|′ signal, thus outputting a signal of |R_{BPF}−Y_{BPF}|/|Y_{BPF}|′.

In addition, the color signal R, which has been supplied from the TV camera, is made to enter a high-pass filter (hereinafter referred to as HPF) 8 serving as a high-frequency component extracting circuit of the present invention. Since the HPF 8 has a high-pass filtering characteristics, as shown in FIG. 2, the HPF 8 operates to extract a high-frequency component of the color signal R and to output a signal of R_{HPF} therefrom.

Both of the extracted signal R_{HPF} and the divided signal |R_{BPF}−Y_{BPF}|/|Y_{BPF}|′ which is outputted from the division circuit 7 are supplied to a multiplication circuit 9. The multiplication circuit 9 multiplies the |R_{BPF|-Y}_{BPF}|/|Y_{BPF}|′ signal by the signal R_{HPF} to produce a signal of |R_{BPF}−Y_{BPF}|·R_{HPF}/|Y_{BPF}|′, which becomes a correction signal for the color signal R. This correction signal |R_{BPF}−Y_{BPF}|·R_{HPF}/|Y_{BPF}|′ is made to enter a gain-adjusting circuit 10.

In the gain-adjusting circuit 10, the correction signal |R_{BPF}−Y_{BPF}|·R_{HPF}/|Y_{BPF}|′ outputted from the multiplication circuit 9 is subjected to its gain adjustment in response to a gain-adjustment signal, so that a gain-adjusted correction signal is given to one input terminal of an addition circuit 11. Supplied to the other input terminal of the addition circuit 11 is the color signal R from the TV camera. Hence the addition circuit 11 operates to add the gain-adjusted correction signal to the color signal R, resulting in that a color signal R′ whose band is not limited can be obtained on an estimation basis. Like the color signal R′, color signals G′ and B′ whose bands are not limited can be obtained.

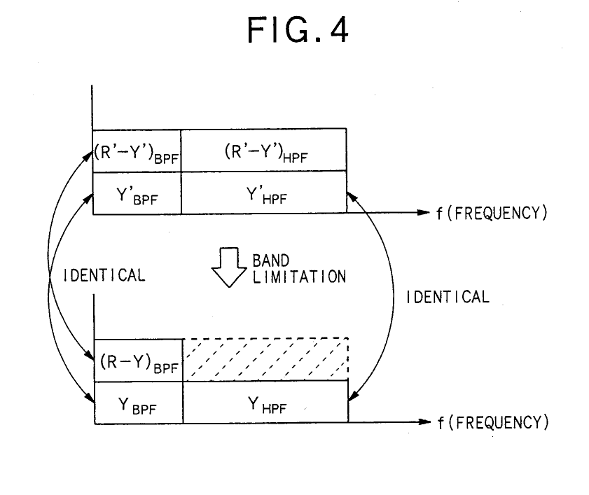

The principle on which the video signal processor is based will now be described with reference to FIG. 4.

As described above, when a color signal obtained after its band limitation is expressed by R (G, B) and a color signal whose band is not limited is expressed by R′ (G′, B′), a relationship of R_{BPF}=R′_{BP} is established in a lower band and a relationship of R_{HPF}=Y′_{HPF} is established in a higher band, respectively.

Hence, a formula of

R′−R=R′_{HPF}−Y′_{HPF}=(R′_{HPF}−Y′_{HPF})·(R_{HPF}−Y′_{HPF}) =(R′_{HPF}−Y′_{HPF})·R_{HPF}/Y′_{HPF}

is realized. If an assumption is made such that a relationship of

Y′_{HPF}: R′_{HPF} [symbol] Y′_{BPF}: R′_{BPF}=Y_{BPF}: R_{BPF}

is realized, that is, if a ratio among the original color signals R′, G′ and B′ is constant over their lower to higher bands, a relationship of

R′ [symbol] R+(R_{BPF}−Y_{BPF})·R_{HPF}/Y_{BPF} (1)

can be formulated. Similarly, formulas of

G′ [symbol] G+(G_{BPF}−Y_{BPF}) G_{HPF}/Y_{BPF} (2)

B′ [symbol] B+(B_{BPF}−Y_{BPF}) B_{HPF}/Y_{BPF} (3)

can be provided.

Accordingly, the color signals R′, G′ and B′ whose bands are not limited can be estimated.

In other words, in cases where a ratio of R′: G′: B′ is constant over their frequency bands (i.e., independent of their frequency bands), a ratio of R′: Y′ is also constant over their frequency bands. Accordingly, as shown in FIG. 4, if a relationship of

(R′_{BPF}−Y′_{BPF}): Y′_{BPF}=(R′_{HPF}−Y′_{HPF}): Y′_{HPF}

is assumed, this formula can be rewritten into

(R_{BPF}−Y_{BPF}): Y_{BPF}=(R′_{HPF}−R_{HPF}): R_{HPF}

by using R′_{BPF}=R_{BPF}, Y′_{BPF}=Y_{BPF}, and Y′_{HPF}=Y_{HPF}=R _{HPF}. Thus, a higher-band correction component (R′_{HPF}−R_{HPF}) can be deduced from only the signals of Y and band-limited R.

As described above, a ratio between a high-frequency component of the color-difference signal R′ of which band is not limited and a high-frequency component of the luminance signal can be estimated on a ratio between a low-frequency component of the band-limited color-difference signal R and a low-frequency component of the luminance signal. This estimated ratio can therefore be used as a multiplication coefficient to a high-frequency component of the color signal whose band has been limited. That is, the coefficient becomes a correction value to be applied to the high-frequency component of the color signal.

Incidentally, FIG. 1 shows the circuitry configuration based on the formula (1), in which, for the sake of convenient processing carried out therein, an assumption of

(R_{BPF}−Y_{BPF})/Y_{BPF}=|R_{BPF}−Y_{BPF}|/|Y_{BPF}|

is made. To avoid the denominator |Y_{BPF}| in the above formula from being too small, the clipping circuit 4 shown in FIG. 1 is configured so that its output |Y_{BPF}| is clipped into a certain constant value at a given value of the input |Y_{BPF}|.

As described, in the present embodiment, the band of each color-difference signal in the color signals, which contributes to color resolution, can be widened, so that the color resolution is improved to a great extent. This avoids color blurs from occurring at boundaries at which color tones change, when the video signal is displayed.

In addition, the gain-adjusting circuit is provided to adjust the gain of the correction signal applied to the color signal, which leads to a more proper estimation of the color signal of which band is not limited.

In the above embodiment, explained is an example in which the color signal R is inputted to the HPF 8 to extract its high-frequency component R_{HPF}. Alternatively, since Y_{HPF}=R_{HPF}=G_{HPF}=B_{HPF} is established, the HPF 8 may be modified to extract any one of a high-frequency component Y_{HPF} of the luminance signal Y, a high-frequency component G_{HPF} of the color signal G, and a high-frequency component B_{HPF} of the color signal B.

Additionally, to prevent the correction value for a high-frequency component of each color signal from being too excessive, an upper-limiting circuit can be placed at the output stage of the division circuit 7 to limit its output to a given value.

The present invention may be embodied in other specific forms without departing from the spirit or essential characteristics thereof. The above embodiments and modifications are therefore to be considered in all respects as illustrative and not restrictive, the scope of the present invention being indicated by the appended claims rather than by the foregoing description and all changes which come within the meaning and range of equivalency of the claims are therefore intended to be embraced therein.

The entire disclosure of Japanese Patent Application No. 2002-33930 filed on Feb. 12, 2002 including the specification, claims, drawings and summary is incorporated herein by reference in its entirety.

What is claimed is:

1. A video signal processor to which a luminance signal and a color signal are supplied, comprising:
a first low-frequency component calculating circuit for calculating a low-frequency component of the luminance signal;
a second low-frequency component calculating circuit for calculating a low-frequency component of a color-difference signal derived from both of the luminance signal and the color signal;
a high-frequency component extracting circuit for extracting a high-frequency component of the color signal;
a division circuit for dividing the low-frequency component of the color-difference signal by the low-frequency component of the luminance signal;
a multiplication circuit for multiplying an output signal from the division circuit by the high-frequency component of the signal extracted from the high-frequency component extracting circuit, a multiplied signal being outputted as a correction signal for the color signal; and
an addition circuit for adding the correction signal to the color signal.

2. The video signal processor according to claim 1, further comprising a gain adjusting circuit for adjusting a gain for the correction signal outputted from the multiplication circuit.

3. The video signal processor according to claim 1, wherein both of the luminance signal and the color signal is given as a video signal from a TV camera, the color signal being subjected to limitation of a frequency band thereof.

4. A video signal processor to which a luminance signal and a color signal are supplied, comprising:
a first low-frequency component calculating circuit for calculating a low-frequency component of the luminance signal;
a second low-frequency component calculating circuit for calculating a low-frequency component of a color-difference signal derived from both of the luminance signal and the color signal;
a high-frequency component extracting circuit for extracting a high-frequency component of the luminance signal;
a division circuit for dividing the low-frequency component of the color-difference signal by the low-frequency component of the luminance signal;
a multiplication circuit for multiplying an output signal from the division circuit by the high-frequency component of the signal extracted from the high-frequency component extracting circuit, a multiplied signal being outputted as a correction signal for the color signal; and
an addition circuit for adding the correction signal to the color signal.
